(19) United States
(12) Patent Application Publication
(10) Pub. No.: US 2015/0246725 A1
(43) Pub. Date: Sep. 3, 2015

(54) PROPULSIVE TAIL PROPELLER ASSEMBLY OR TAIL DUCT FAN ASSEMBLY WITH CYCLIC AND COLLECTIVE CONTROL AND/OR A METHOD OF THRUST VECTORING FOR AIRCRAFT MANEUVERING AND FOR HELICOPTOR SINGLE ROTOR HEAD ANTI TORQUE

(71) Applicant: Nolan Joseph Reilly, Winnetka, CA (US)

(72) Inventor: Nolan Joseph Reilly, Winnetka, CA (US)

(21) Appl. No.: 14/308,326

(22) Filed: Jun. 18, 2014

Related U.S. Application Data
(60) Provisional application No. 61/838,228, filed on Jun. 22, 2013.

(51) Int. Cl. B64C 27/605; B64C 11/32

(52) U.S. Cl. CPC B64C 27/605; B64C 11/32

(57) ABSTRACT

A method of aircraft propulsion and control more specific to rotorcraft propulsion and control using forward, neutral and aft thrust in addition to forward/aft thrust coupling from the propulsive tail assembly through cyclic and collective pitch of the non-flapping, ridged propeller/fan blades and/or from a turbojet/turbofan vectored thrust system. The cyclic blade pitch induces a drive shaft bending moment that is used to provide aircraft directional control and also provides anti-torque control for a single rotor head helicopter. The forward/reverse collective thrust actuator, phase lag elevator effect cyclic actuator and phase lag rudder/anti-torque effect cyclic actuator do not require complex control mixing. The vectored thrust system also provides aircraft directional control and anti-torque control individually or combined with the propeller/fan assembly. This assembly eliminates the requirement of rudder or elevator control on a fixed wing aircraft and the requirement of a tail rotor on a conventional helicopter while increasing speed and maneuverability. A slowed or stopped ridged X-wing rotorcraft hub with a modified circular arc airfoil would not require cyclic/collective control.

### BACKGROUND OF THE INVENTION

The present invention relates to an aircraft propulsion and control system, and more specific to a rotorcraft propulsion and control system for propeller/fan blade pitch control that induces a drive shaft bending moment and/or a turbojet/turbofan vectored thrust system that is used to provide aircraft directional control and also provides anti-torque control. This system also provides all of the forward, neutral and aft thrust required for a rotorcraft to rapidly accelerate to full speed after transitioning from hover and then to rapidly decelerate back to hover from a forward or reverse flight direction.

Current rotorcraft are limited by speed, maneuverability, altitude or lift efficiency. Helicopters have a high lift efficiency because of their large disc area which results in a low disc loading but are limited in speed, maneuverability, altitude and range. These problems are caused by dissymmetry of lift, the high angle of nose pitch, drag from the rotor disc and the low percentage of lift produced from the inner span of the rotor blades.

Tilt rotors have a lower lift efficiency because the disc area is divided into two smaller disc's which results in higher disc loading. This requires more power to achieve the same amount of lifting force as a rotorcraft with a single large disc area and causes instability because the disc's are out of plane with the center of gravity. The maneuverability is reduced at low speed and hover due to the use of prop rotors that are being used for vertical lift. The speed, altitude and range are increased because the wing is used for lift at higher speeds which eliminates the requirement to use the prop rotors for lift. The dissymmetry of lift associated with a helicopter is also eliminated. The problem that occurs with a prop rotor used for vertical lift and propulsion is the drag from the wing when in hover and the drag from the large disc's when in forward flight.

The best solution to overcome the inherent problems associated with the different types of rotorcraft is to combine the best features. A rotorcraft with a large single disc rotor hub would offer the best lift efficiency and least amount of drag. A propulsive propeller/fan and/or a turbojet/turbofan vectored thrust system that is not used for vertical lift would offer the most efficient means of propulsion. A wing would be the most efficient solution of reaching high speed, altitude and range but would increase weight and vertical lift drag. A coaxial helicopter would eliminate dissymmetry of lift but would increase weight and drag. Compound helicopter's combine some of the advantages of these features but are penalized by the same decrease in performance associated with them. The best solution for efficient vertical lift and efficient sustained high speed flight would utilize a high lift, low drag X-wing main rotor head and rotor wing blade for vertical lift that transitions to a slowed or stopped wing in flight combined with a propulsive tail propeller and/or a turbojet/turbofan vectored thrust system that provides all flight thrust and that controls all maneuvering and anti-torque during hover and flight.

### BRIEF SUMMARY OF THE INVENTION

The present invention provides in one embodiment, an aircraft propulsion and control system which generates cyclic and collective pitch with rigidly mounted propeller/fan blades for aircraft maneuvering and helicopter anti-torque and thereby eliminating the problems associated with low speed rudder or elevator control, main rotor control and helicopter tail rotor control. With the embodiment utilized, the internal turbo shaft engine or engines provide power to the main rotor shaft through rotation and drives the main rotor hub which is used for vertical hover lift and for sustained flight lift and/or the propulsive tail propeller/fan drive shaft that drives the propeller/fan hub which is used for all forward or reverse propulsion and maneuvering control.

Forward, neutral and reverse collective thrust control is powered by a single actuator that drives a mechanical linkage that is connected to a tubular sliding assembly. The sliding assembly when driven, moves forward or aft on the exterior surface of the rotating drive shaft and remains stationary from rotation. The forward base end of two actuators are attached to the forward end of the sliding assembly exterior surface 90 degrees apart from each other on the top and port side of the sliding assembly and are parallel to the longitudinal axis of the drive shaft and the sliding assembly. The aft rod end of the two actuators are attached the inner non rotating swashplate located at the aft end of the sliding assembly. The forward inner non rotating swashplate is attached to the aft outer rotating swashplate by a bearing that allows the outer swashplate to rotate about the inner swashplate. The inner and outer swashplate assembly rotate about a fixed spherical bearing which is attached to the aft end of the sliding assembly exterior surface.

The top and port side actuators on the sliding assembly control the cyclic pitch and yaw of the aircraft when they collectively cause the swashplate assembly to tilt in any direction about the longitudinal drive shaft axis. Propeller/fan blades are attached to the propeller/fan hub by pitch horns and rotate perpendicular to the rotational axis of the hub. The propeller/fans blades and pitch horns are directly linked to the outer rotating swashplate by mechanical linkage. The tilted angle of the swashplate directly drives the pitch angle of the propeller/fan blades as the swashplate and propeller/fan hub rotate in sync about the longitudinal drive shaft axis. The cyclic pitch of the rotating propeller/fan blades causes a bending moment on the drive shaft which gives the aircraft pitch and yaw control. Pitch control is equivalent to the elevator control on the tail of a fixed wing aircraft. Yaw control is equivalent to the rudder control on the tail of a fixed wing aircraft. Rudder control is also equivalent to the tail rotor rudder and anti-torque control on a conventional single rotor head helicopter.

In another embodiment that is combined with the first embodiment or used alone, a turbojet or turbofan engine provides the thrust for propulsion in a forward or reverse direction, for maneuvering, anti-torque and for partial or total vertical lift. The exhaust chamber aft of the engine transitions from the round section of the engine to a rectangular cross section. This duct contains modules that are positioned along the duct. The module is comprised of a length of duct that has cutout sections on opposing faces. Were each cutout exists, a hinged door diverter vane seals the cutout flush on the inside surface of the duct so that the engine exhaust gas is sealed within the duct and provides smooth laminar flow through the duct. The door diverter vane which shall called a (DDV) and can open inward up to 45 degrees with the forward edge transitioning into the exhaust stream of the engine. Each DDV is hinged on its aft edge to the aft edge of each cutout in the duct. Each DDV is transitioned by strut arm(s) that provide the connection between the DDV and the sliding assembly. A single strut arm is used to transition each of the four lateral control DDV's and attaches to the center of the triangular panel which pivots about a hinge in that is located in a small center cutout in the panel. The two reverse thrust control DDV's that are rectangular in shape, have two strut arms attached to each. The strut arms attach to the center edges of each DDV and pivot about a hinge pin that protrudes out from each edge. The strut arm(s) are then each attached to a sliding assembly that transitions forward and aft in a set of tracks that are located at the center of the triangular lateral control cutouts or on the side edges of the reverse thrust control cutouts. The tracks extend from the forward frame at the forward edge of the cutouts to the the aft frame on the aft edge of each cutout. The tracks also extend between the inner mold line of the exterior skin and the outer mold line of the duct.

The sliding assembly or assemblies that control each DDV are translated by an actuator that is positioned on the forward side of each cutout and aligned in a longitudinal direction with the sliding assembly. The translating rod end of the actuator is attached directly to the slide fitting that is part of the sliding assembly. The bolt connection in the slide fitting is shared for attachment of the actuator rod end and the pivoting lug end of the strut arm. The area normal to the outer face of the cutout that lies between outer surface of the duct and the inner surface of outer skin contains a fixed exhaust grate or cascade. This grate directs the engine exhaust normal to the duct through the lateral control cutouts or at 45 degrees toward the front through the thrust reverser control cutouts when the DDV is in the open position. The exhaust grate contains rectangular cells that are parallel to each other and are used to divert and direct the exhaust flow in a uniform direction through the cutout that exists in the duct and out through the identical sized cutout that exists in the outer skin. The outer perimeter of the exhaust grate seals the gap between the duct skin and the outer skin so that the exhaust flow can only flow out of the aircraft. The outer perimeter of the exhaust grate is attached to the frames that border the edges of the cutout.

The outer surface of the exhaust grate at the aircraft skin boundary is cover with hinged slats that open parallel with the forward/aft airflow of the aircraft when flying and parallel with the longitudinal direction of the duct in a clam shell pattern. Each slate has a light spring load that allows the exhaust to exit the grate when the DDV is slightly opened. When the slats are in the closed position, the slats provide an aerodynamic boundary surface when the thrust vectoring is not in use. The slat is closed and flush with the outer aircraft skin when it is not being blown open. The exhaust flow does not occur when the DDV is closed and sealed against the duct which blocks the duct cutout opening. Each DDV opens to a maximum of 45 degrees into the exhaust stream inside the duct. The lateral control DDV's must fully close before the opposing DDV can begin to open. This is a function of the cockpit controls which will not allow both rudder pedals to be depressed at the same time or a steering wheel to be pushed forward and pulled backward at the same time. The second or aft module that controls the reverse thrust vectoring would be controlled from the cockpit using a directional control lever. This module would require both opposing DDV's to open or close at the same linear rate inorder to provide uniform opposing thrust in a lateral direction from the duct and in an equal forward direction to provide thrust reversing. When both opposing DDV's are opened to the maximum 45 degrees, the aft thrust from the duct is completely stopped and the forward thrust would be at a maximum. This position would be used for transitioning from hover to a reverse flight direction or for rapid deceleration from forward flight or for a fixed rotor wing mode runway landing. This position also allows for full control thrust for vertical and horizontal maneuvering from the other module. When the DDV's are opened approximately 60 percent, the thrust reversing force will equal the aft thrust and thus produce a neutral thrust required for hovering. The balance of forward and reverse thrust would be controlled by the directional control lever which opens or closes the DDV's providing thrust when required. A fixed exhaust deflection airfoil can be placed on both sides of the reverse thrust exhaust port to further deflect the 45 degree reverse thrust to 90 degrees or a full forward direction inorder to provide more efficient reverse thrust control. A third and fourth module can be arranged in any sequence with the lateral control and thrust reversing modules. These modules would have a single rectangular cutout each with a similar arrangement of control as the thrust reverser module accept would have only one exhaust grate located on the bottom duct face with cells that divert the exhaust thrust at 90 degrees to the longitudinal direction of the duct. The aspect ratio of these cutouts relative to the length of the duct would be double the aspect ratio of the thrust reverser cutouts so that the (DDV) would be able to block the entire cross section of the duct when opened 45 degrees and thus divert 100 percent of the exhaust thrust down through the cutout normal to the outer skin surface for vertical lift. Two modules would be able to balance the total vertical lift required.

### BRIEF DESCRIPTION OF THE SEVERAL VIEWS OF THE DRAWING

FIG. 1 is a open port side partial hidden line view of the propeller/fan system in the neutral collective/cyclic thrust middle position.

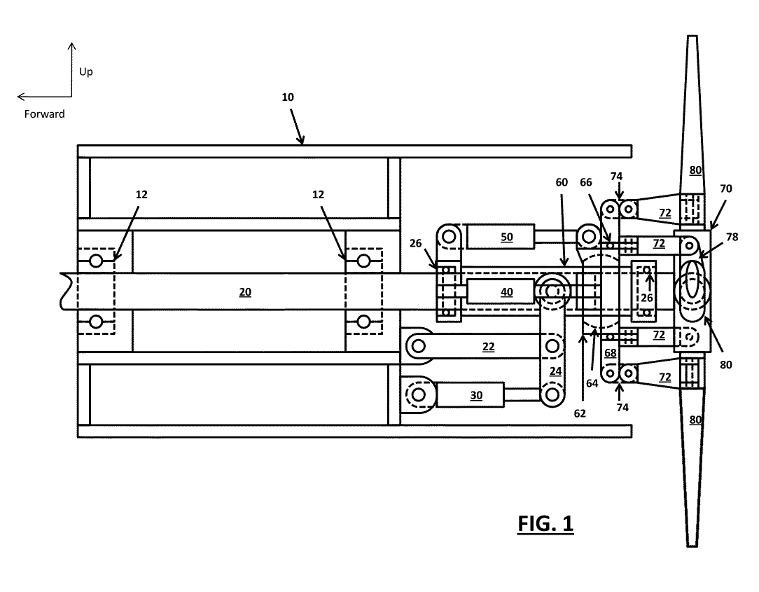

FIG. 2 is a open bottom partial hidden line view of the propeller/fan system in the neutral collective/cyclic thrust middle position.

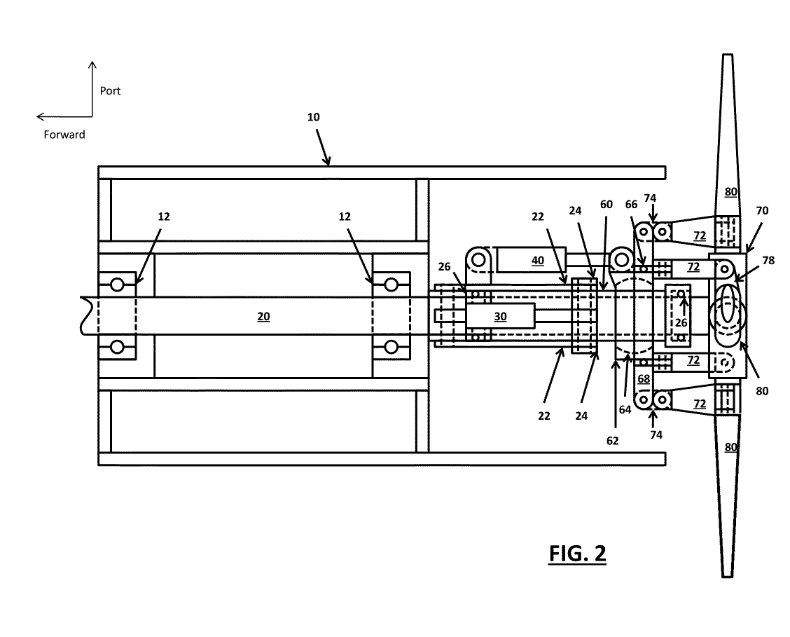

FIG. 3 is a back partial hidden line view of the propeller/fan hub assembly and the swashplate assembly.

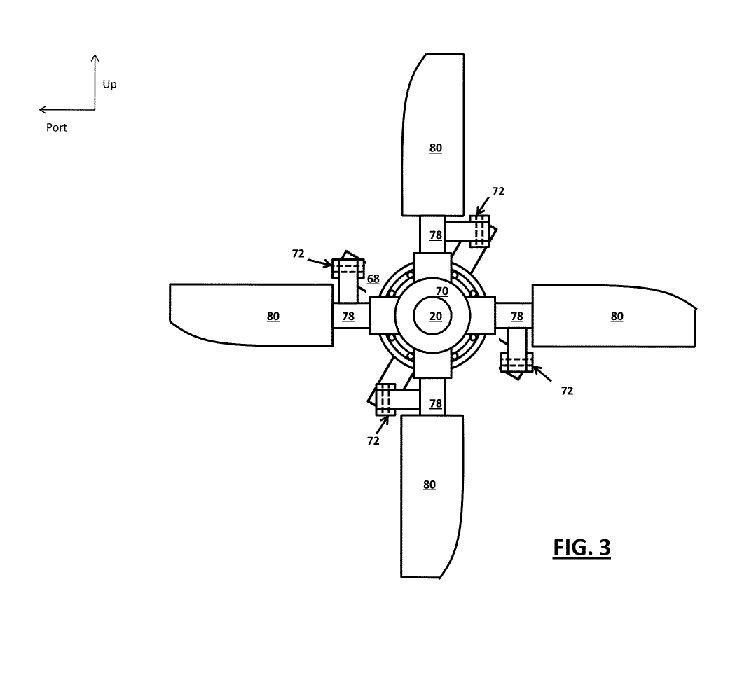

FIG. 4 is a back partial hidden line view of the propeller/fan hub assembly.

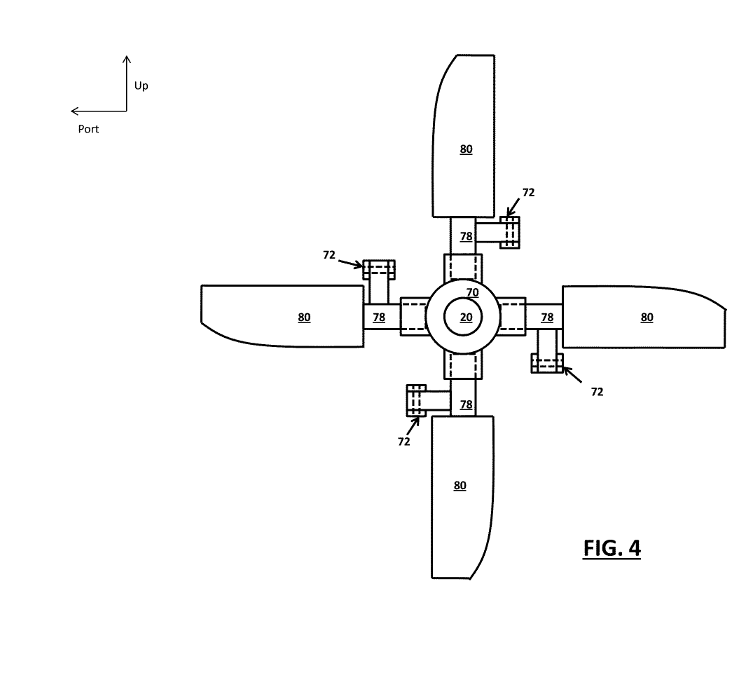

FIG. 5 is a back partial hidden line view of the swashplate assembly.

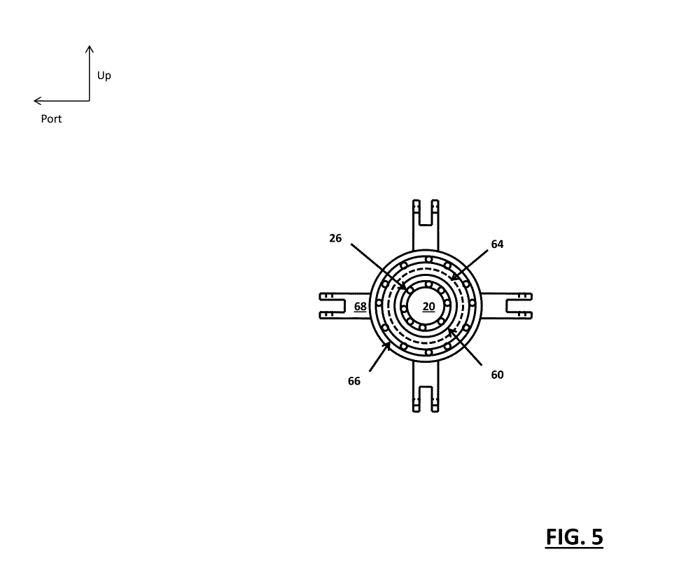

FIG. 6 is a open port side partial hidden line view of the enclosed propeller/fan system in the neutral collective/cyclic thrust middle position.

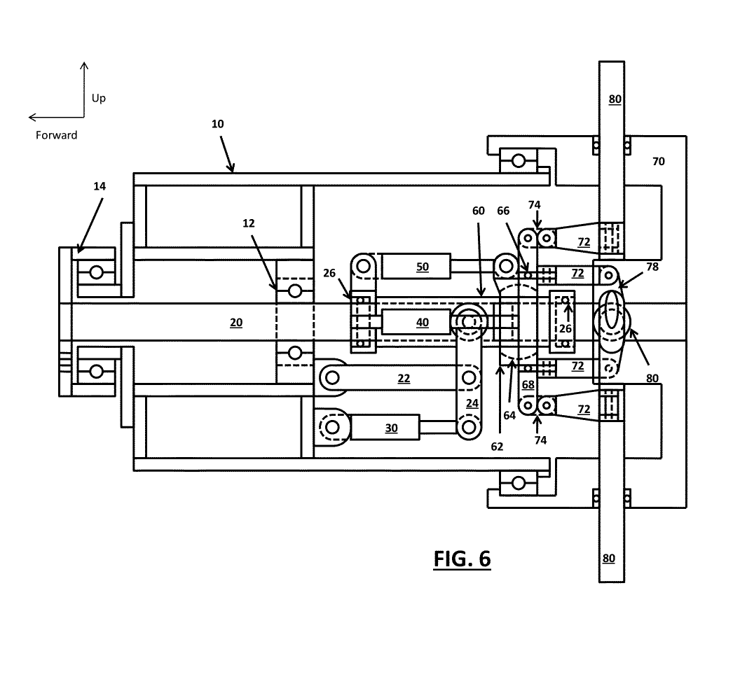

FIG. 7 is a open bottom partial hidden line view of the enclosed propeller/fan system in the neutral collective/cyclic thrust middle position.

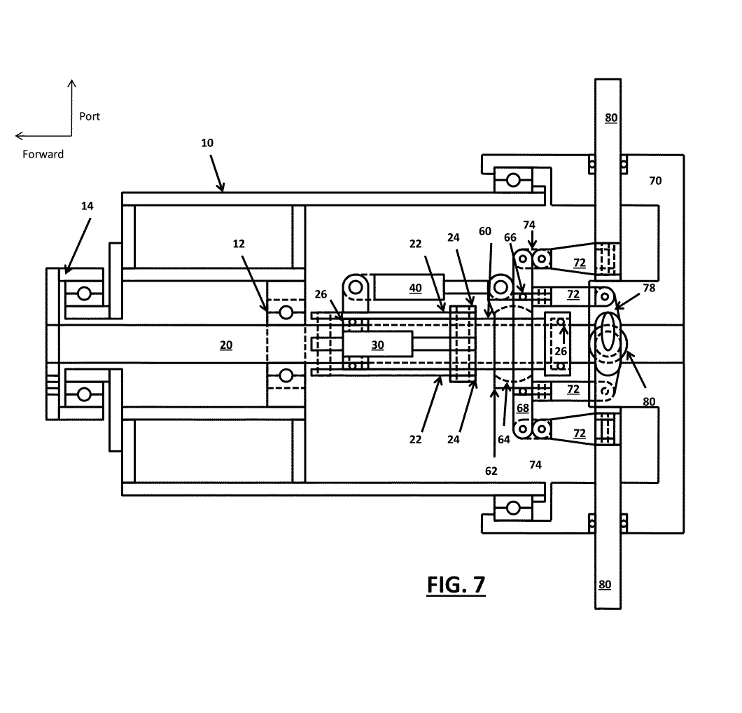

FIG. 8 is a back partial hidden line view of the enclosed propeller/fan hub assembly and the swashplate assembly.

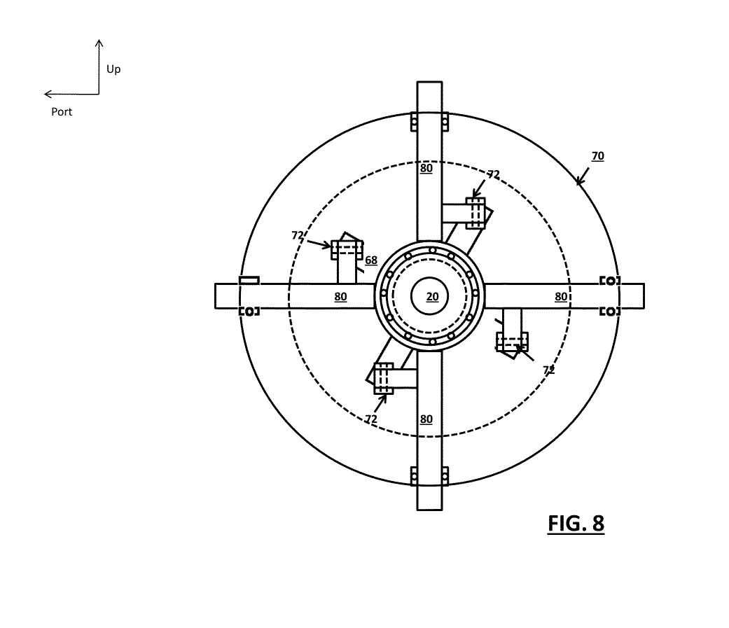

FIG. 9 is a open port side partial hidden line view of the combined jet thrust duct and propeller/fan system in the neutral collective/cyclic thrust middle position.

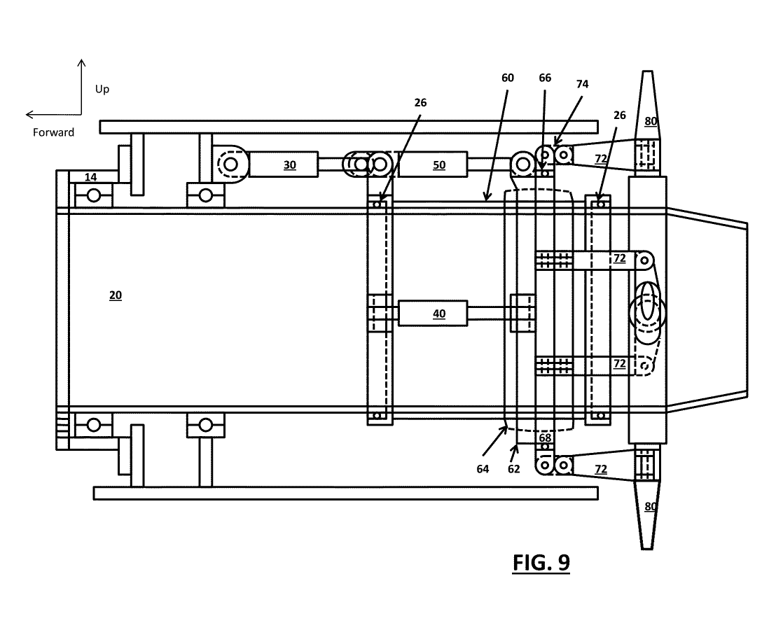

FIG. 10 is a open bottom partial hidden line view of the combined jet thrust duct and propeller/fan system in the neutral collective/cyclic thrust middle position.

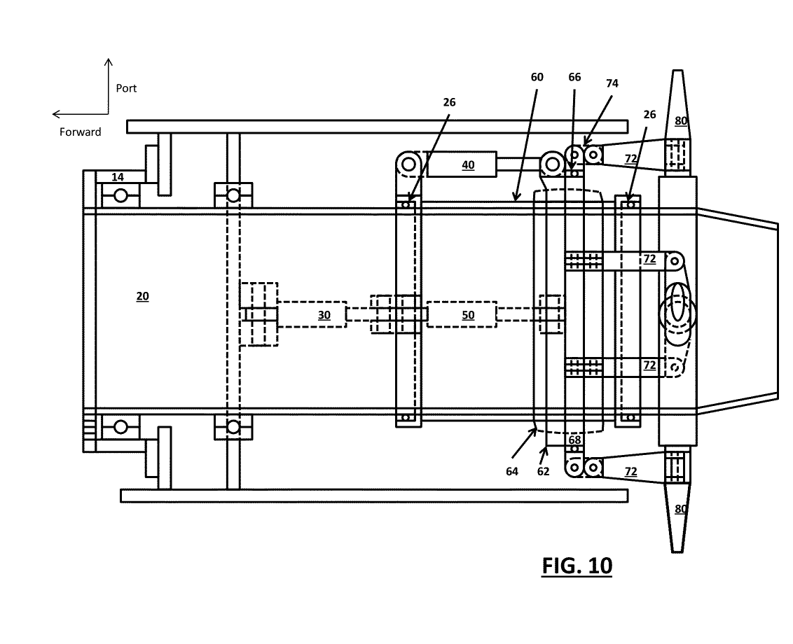

FIG. 11 is a open port side partial hidden line view of the turbojet/turbofan powered vectored thrust maneuvering control system in the fully closed position.

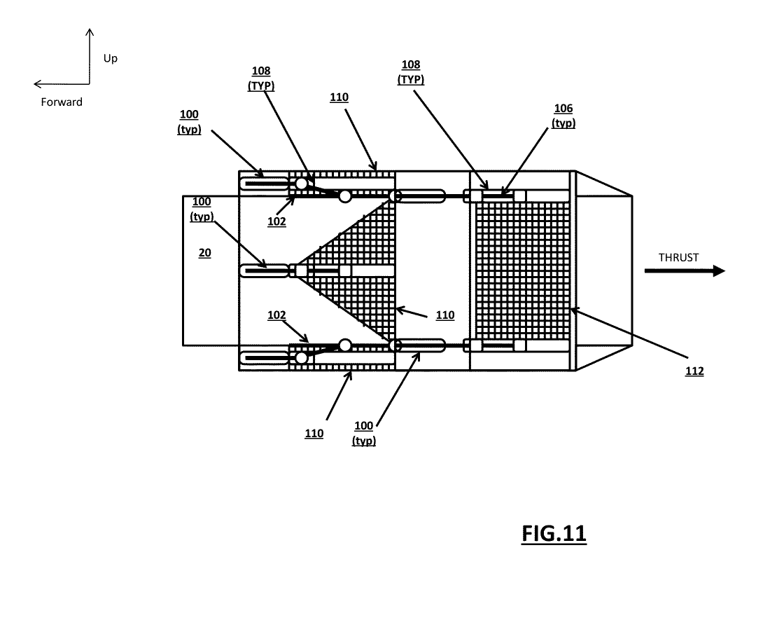

FIG. 12 is a open bottom partial hidden line view of the turbojet/turbofan powered vectored thrust maneuvering control system in the fully closed position.

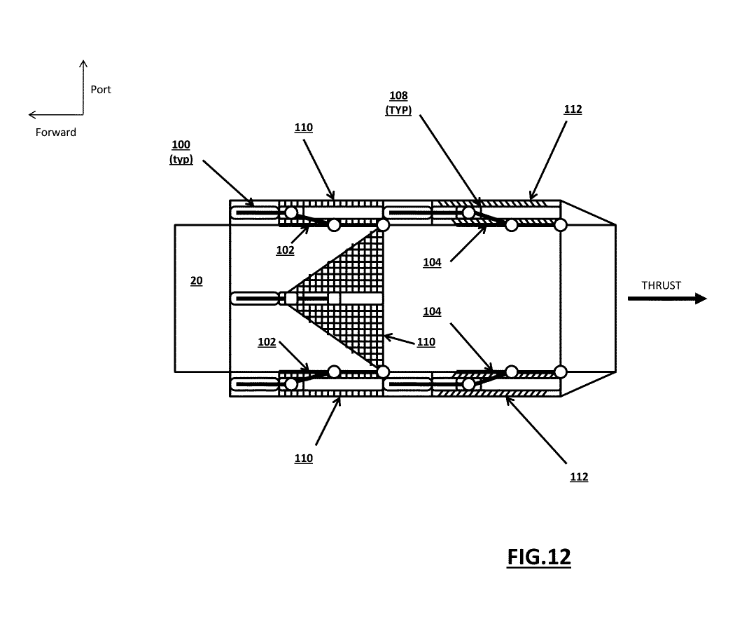

FIG. 13 is a open port side partial hidden line view of the turbojet/turbofan powered vectored thrust maneuvering control system with a partially open lateral control module.

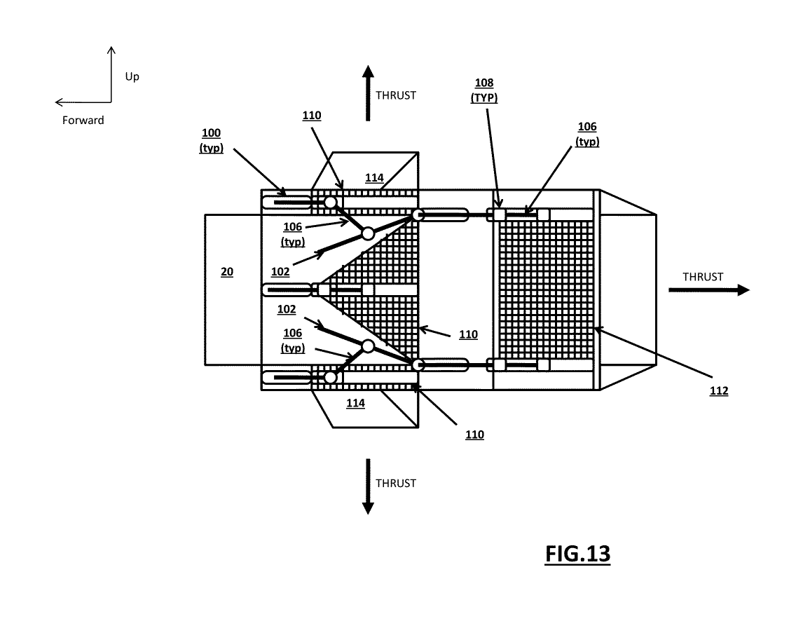

FIG. 14 is a open bottom partial hidden line view of the turbojet/turbofan powered vectored thrust maneuvering control system with a partially open thrust reversing control module.

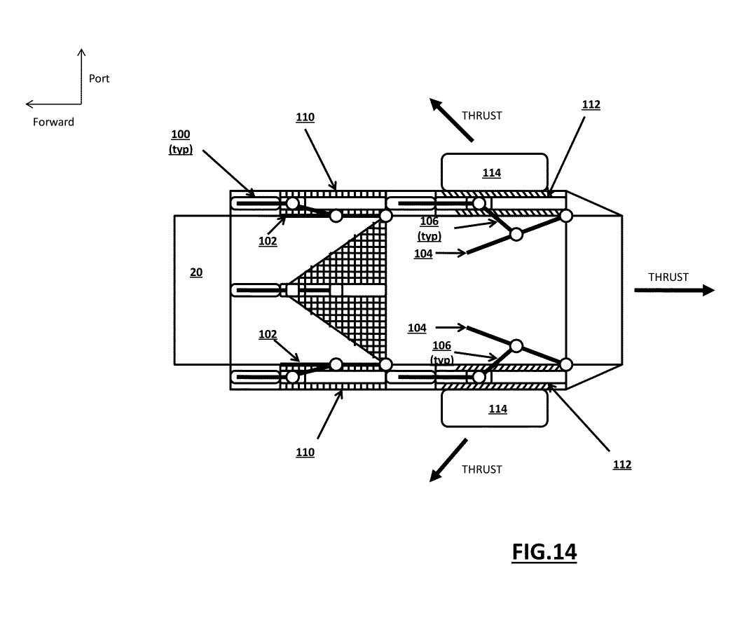

FIG. 15 is a open port side partial hidden line view of the turbojet/turbofan powered vectored thrust maneuvering control system with two opposite door diverter vanes fully opened in the lateral control module.

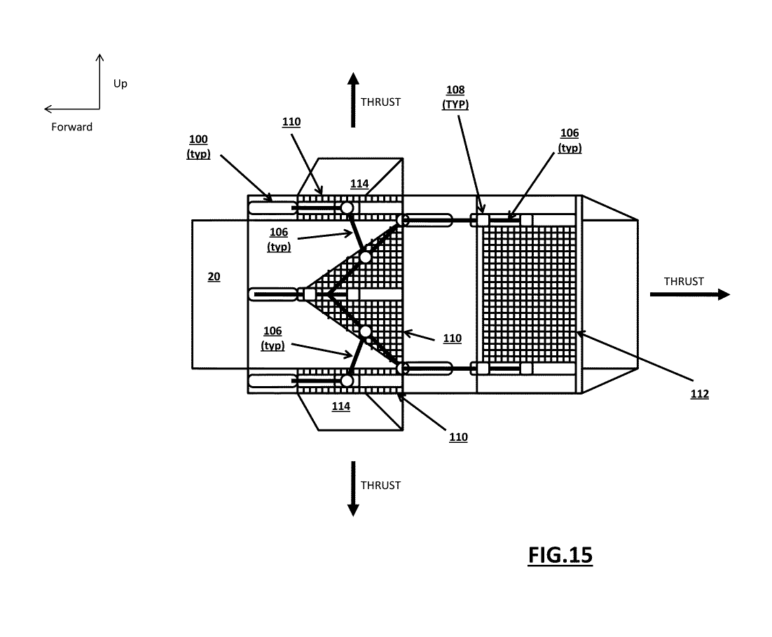

FIG. 16 is a open bottom partial hidden line view of the turbojet/turbofan powered vectored thrust maneuvering control system with all two opposite door diverter vanes fully open in the thrust reversing control module.

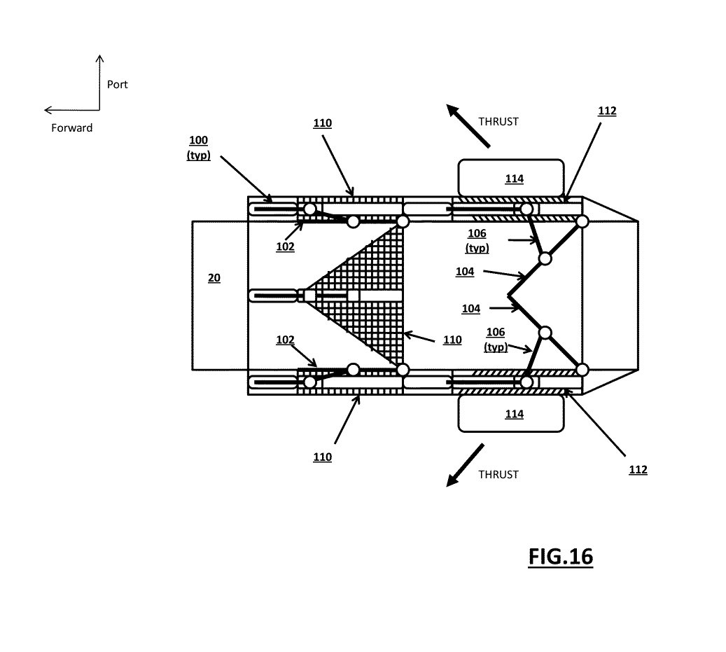

FIG. 17 is a open front side partial hidden line view of the turbojet/turbofan powered vectored thrust maneuvering control system with all four door diverter vanes fully opened in the lateral control module.

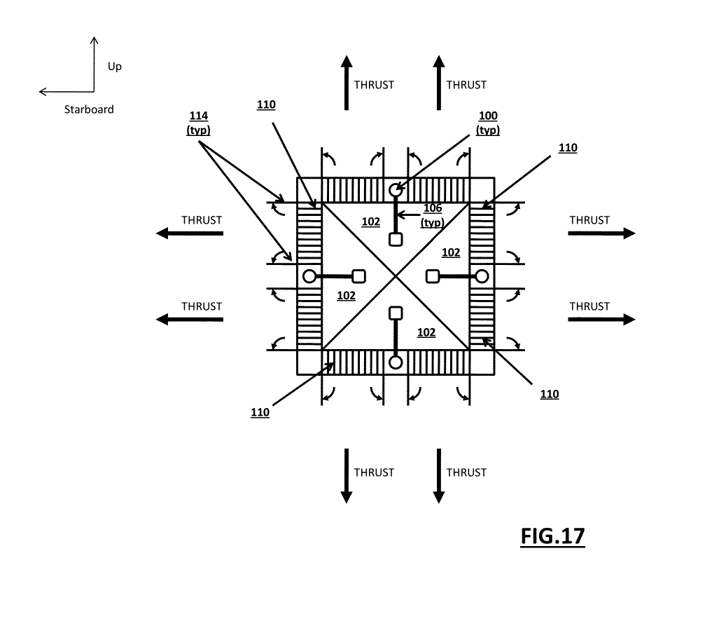

FIG. 18 is a open front side partial hidden line view of the turbojet/turbofan powered vectored thrust maneuvering control system with all two opposite door diverter vanes fully open in the thrust reversing control module.

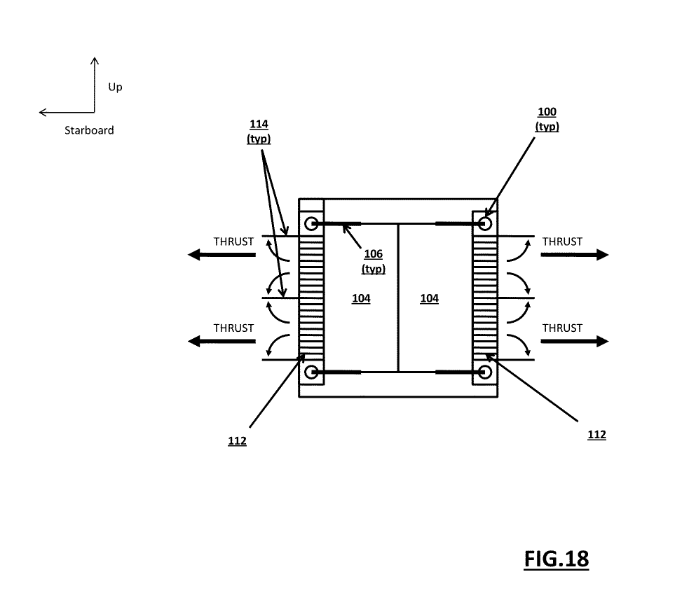

FIG. 19 is a isometric view of an X-wing rotorcraft embodiment utilizing the tail duct fan assembly.

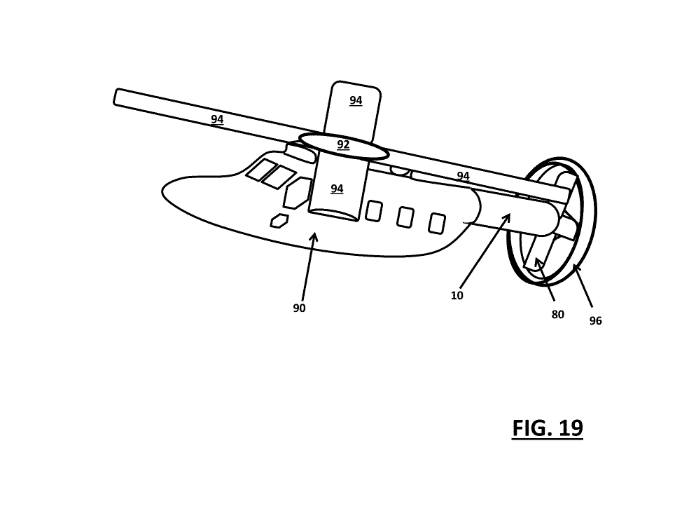

FIG. 20 is a port side view of an X-wing rotorcraft embodiment utilizing the tail duct fan assembly.

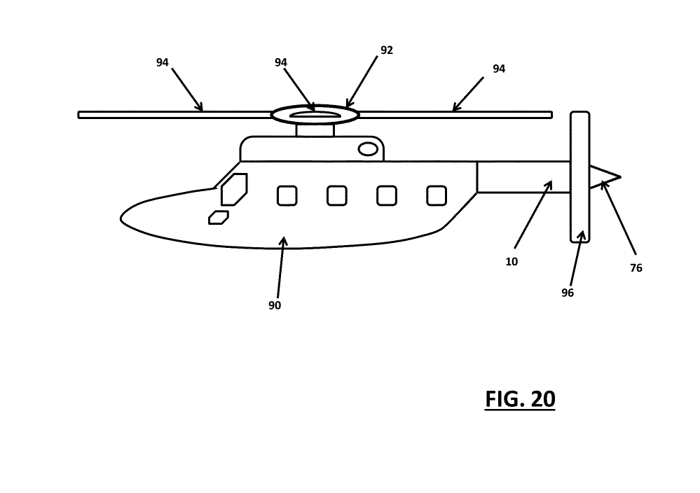

FIG. 21 is a top view of an X-wing rotorcraft embodiment utilizing the tail duct fan assembly.

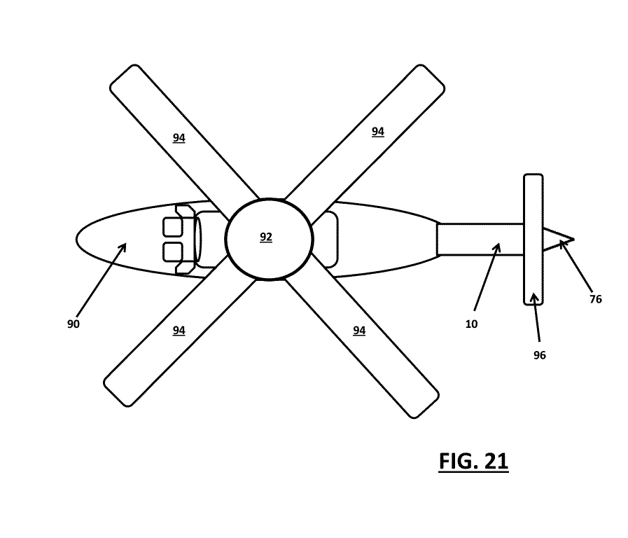

FIG. 22 is a top view of an hydro-static drive system using two turbojet engines connected to two clutched hydrostatic pumps to power two hydrostatic motors which power a main rotor shaft and tail propeller shaft that can utilize a tail propeller/duct fan assembly.

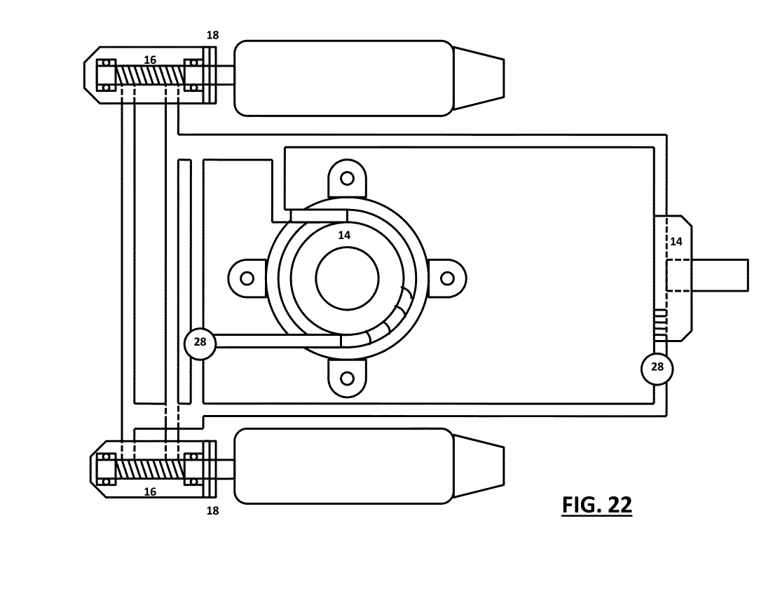

FIG. 23 is a port side view of an X-wing rotorcraft embodiment utilizing the tail duct fan assembly.

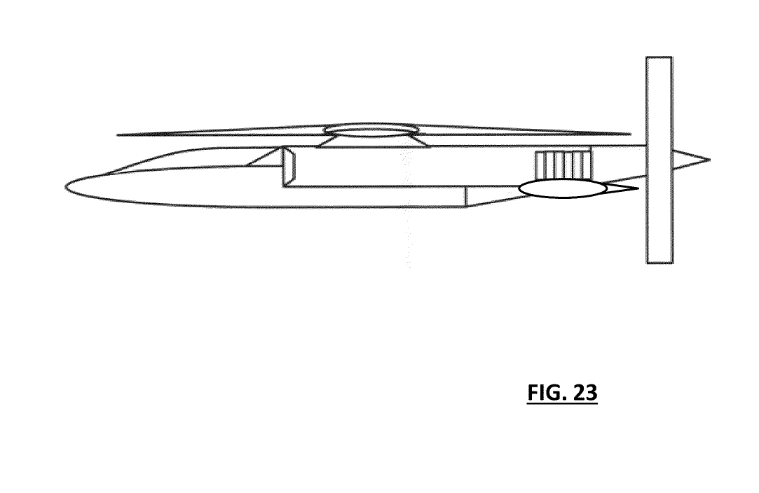

FIG. 24 is a port side view of an X-wing rotorcraft embodiment utilizing the tail duct fan assembly with landing gear extended.

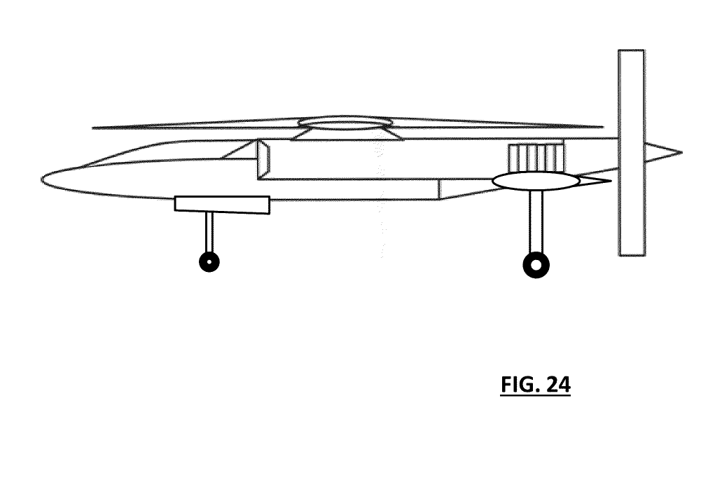

FIG. 25 is a port side view of an X-wing rotorcraft embodiment utilizing the turbojet powered vectored thrust control system for propulsion with lateral and thrust reversing control with landing gear extended.

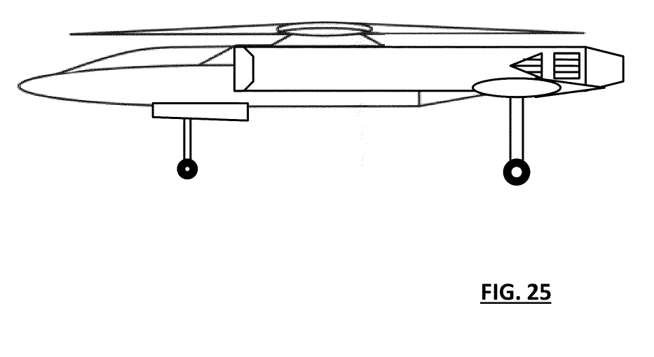

FIG. 26 is a front side view of an X-wing rotorcraft embodiment utilizing the propeller assembly system with landing gear extended.

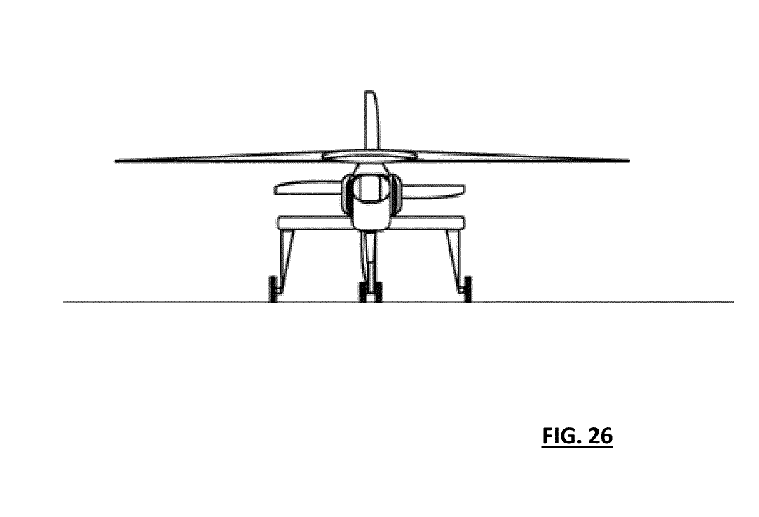

FIG. 27 is a top side view of an X-wing rotorcraft embodiment utilizing the tail duct fan assembly.

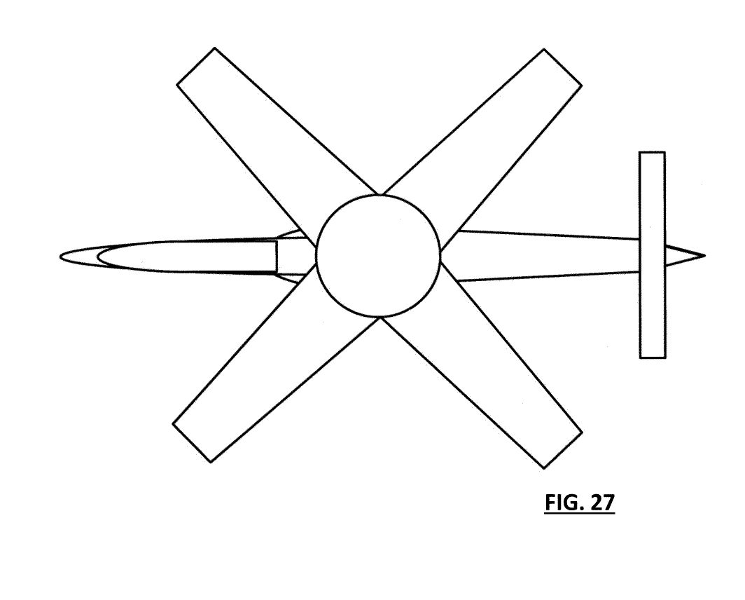

FIG. 28 is a port side view of an X-wing rotorcraft embodiment utilizing the propeller assembly system and a hydrostatic drive system.

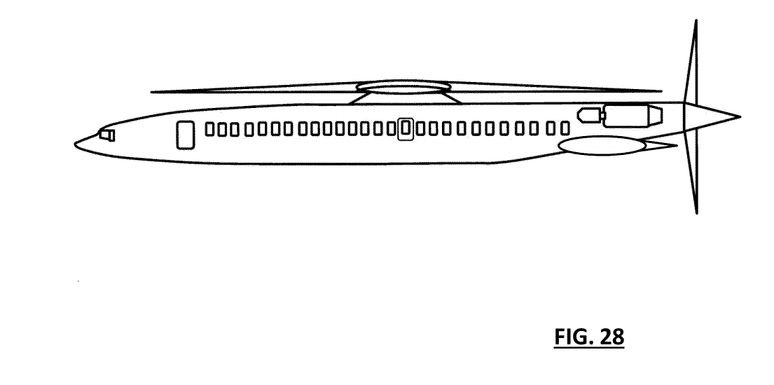

FIG. 29 is a port side view of an X-wing rotorcraft embodiment utilizing the propeller assembly system and a hydrostatic drive system with landing gear extended.

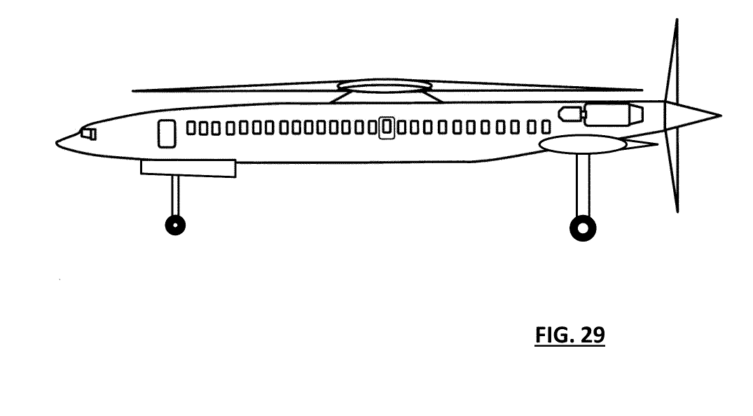

FIG. 30 is a front side view of an X-wing rotorcraft embodiment utilizing the propeller assembly system and a hydrostatic drive system with landing gear extended.

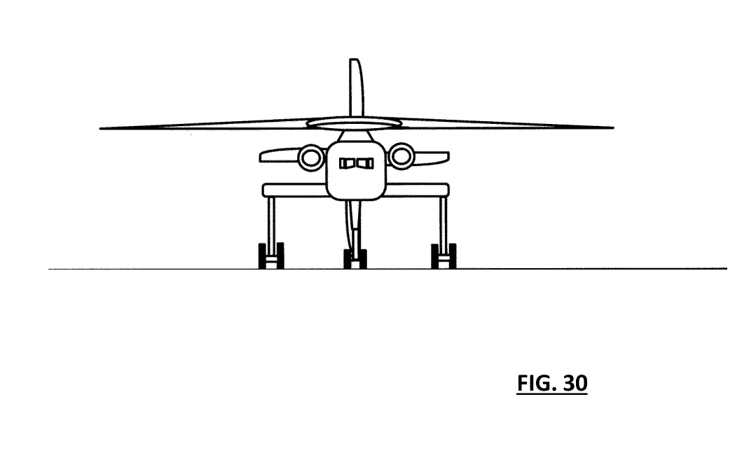

FIG. 31 is a top side view of an X-wing rotorcraft embodiment utilizing the propeller assembly system and a hydrostatic drive system.

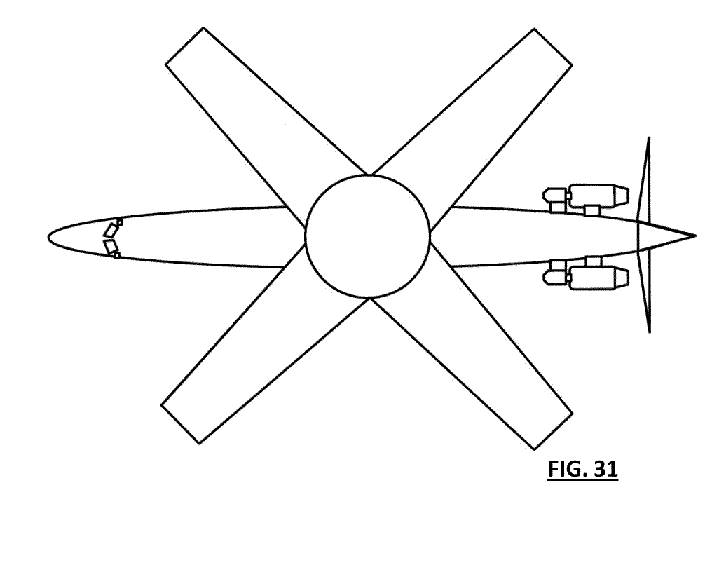

FIG. 32 is a list of reference characters and their corresponding part names.

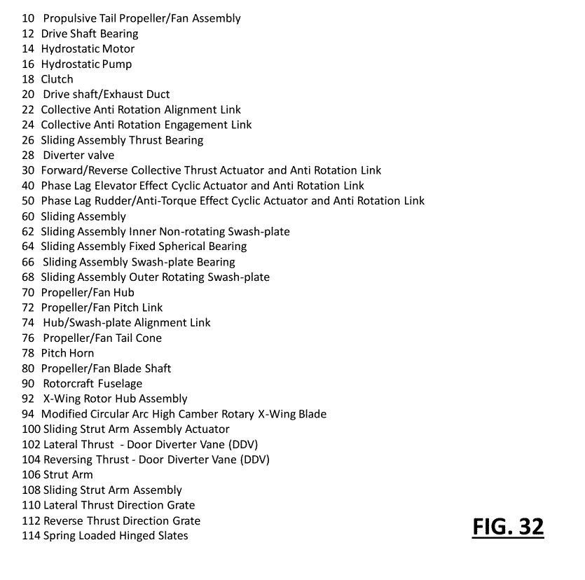

### DETAILED DESCRIPTION OF THE INVENTION

The propulsive tail propeller/fan assembly 10 maneuvering control system depicted by this embodiment can produce all of the forward, neutral and aft thrust required to accelerate, continuously propel and decelerate an aircraft in a forward or reverse flight direction. The system can also provide the aircraft directional control including pitch, yaw and helicopter single rotor head anti-torque. This is dependent on the drive shaft 20 horse power, propeller/fan blade 80 length, the plurality of the propeller/fan blade 80, rotational speed of the drive shaft 20, propeller/fan blade 80 airfoil and the collective or cyclic propeller/fan blade 80 pitch. The drive shaft 20 is mounted within the drive shaft bearing 12 at two locations along the drive shaft 20 which are supported by the tail assembly 10 airframe structure. The drive shaft bearing 12 allows free rotation of the drive shaft and acts to support it from bending. The large diameter of the drive shaft 20 that transverses the tail propeller/fan assembly 10 acts as the main structural support for the dynamic components that are attached to the drive shaft 20.

Forward, neutral and reverse thrust control is powered by the forward/reverse collective thrust actuator 30. The actuator 30 is connected to the collective anti-rotation engagement link 24. This link is connected to the collective anti-rotation alignment link 22 which acts as an adjustable fulcrum. The collective anti-rotation engagement link 24 is then connected to the sliding assembly 60 at a hinge pad that is located on both sides of the sliding assembly 60. The translation of the sliding assembly 60 along the longitudinal drive shaft 20 axis direction of the drive shaft 20 is proportional to the translation of the forward/reverse collective thrust actuator 30 rod end. The collective anti-rotation engagement link 24 provides translation to the sliding assembly 60 and also prevents it from rotating about the drive shaft 20.

The sliding assembly 60 glides on the outer surface of the drive shaft 20 through use of the sliding assembly thrust bearing 26 located at each end of the sliding assembly 60. The outer race of each thrust bearing 26 is press fit into the housing bore on each end of the sliding assembly 60 and remains stationary relative to the sliding assembly 60. The inner race of each thrust bearing 26 rotates relative to the sliding assembly 60 and slides on the drive shaft 20. The inner diameter of the inner race has a loose fit female spline that mates with the lubricated male spline on the outer diameter of the drive shaft 20.

The sliding assembly 60 has two sets of rod end flange connections at the forward end of the assembly that are oriented 90 degrees apart. The upper flange set is used to connect the phase lag rudder/anti-torque effect cyclic actuator 50. The port side flange set is used to connect the phase lag elevator effect cyclic actuator 40. On the aft end of the sliding assembly 60, the inside diameter of the sliding assembly fixed spherical bearing 64 is attached to the outside diameter of the sliding assembly 60 by weldment, swaging, mechanical thread locking or fastening or machined as a single piece.

The sliding assembly inner non rotating swashplate 62 is assembled from a forward and aft section that mates at the maximum diameter center line of the fixed spherical bearing 64. Both sections have an inner mold line that matches the outer mold line of the fixed spherical bearing 64 and are attached together by mechanical thread locking or fastening in order to fully encompass the fixed spherical bearing 64 and provide a swiveling socket that is lubricated. The forward section of the sliding assembly inner non rotating swashplate 62 has two sets of rod end flange connections that are 90 degrees apart. The upper flange set is used to connect the phase lag rudder/anti-torque effect cyclic actuator 50. The port side flange set is used to connect the phase lag elevator effect cyclic actuator 40. The inner diameter of the inner race of the sliding assembly swashplate bearing 66 is press fit on to the outer diameter of the aft section of the sliding assembly inner non rotating swashplate 62. The outside diameter of the outer race of the sliding assembly swashplate bearing 66 is press fit into the inner diameter of the sliding assembly outer rotating swashplate 68. This method of assembly allows the sliding assembly outer rotating swashplate 68 to rotate about the sliding assembly inner non rotating swashplate 62 and still maintain continuity.

The phase lag rudder/anti-torque effect cyclic actuator 50 is attached to the upper forward flange set on the sliding assembly 60 in such a way that the bolted connection allows rotation of the actuator 50 around the longitudinal axis of the bolt but does not allow rotation of the actuator 50 around any axis perpendicular to the longitudinal axis of the bolt. This form of attachment provides a method of anti-rotation for the sliding assembly inner non rotating swashplate 62. The aft actuator 50 piston rod end is attached to the upper flange set on the sliding assembly inner non rotating swashplate 62 and completes the connection of phase lag rudder/anti-torque effect cyclic actuator 50.

The phase lag elevator effect cyclic actuator 40 is attached to the port side forward flange set on the sliding assembly 60 in such a way that the bolted connection allows rotation of the actuator 40 around the longitudinal axis of the bolt but does not allow rotation of the actuator 40 around any axis perpendicular to the longitudinal axis of the bolt. This form of attachment provides a method of anti-rotation for the sliding assembly inner non rotating swashplate 62. The aft actuator 40 piston rod end is attached to the port side flange set on the sliding assembly inner non rotating swashplate 62 and completes the connection of the phase lag elevator effect cyclic actuator 40.

The sliding assembly outer rotating swashplate 68 has a plurality of sets of drive flanges that are located on the outermost arms relative to the rotational axis of the swashplate 68. The forward end of the plurality of hub/swashplate alignment links 74 are each attached to the drive flanges by a bolted connection. The hub/swashplate alignment link 74 has a fixed rod end connection with the drive flanges that allows rotation around the longitudinal axis of the bolt and rotation around any axis perpendicular to the longitudinal axis of the bolt. The aft end of each hub/swashplate alignment link 74 is attached to the forward end of the propeller/fan pitch link 72 by a bolted connection that allows rotation around the longitudinal axis of the bolt but does not allow rotation around any axis perpendicular to the longitudinal axis of the bolt. The longitudinal axis of the hub/swashplate alignment link 74 bolted connection with the sliding assembly outer rotating swashplate 68 is parallel to the longitudinal axis of the bolted connection with the propeller/fan pitch link 72 but is offset at a rotational angle around the longitudinal axis of the hub/swashplate alignment link 74. This angle matches the offset angular plane through the drive shaft 20 longitudinal axis that exists between the centerline of the sliding assembly outer rotating swashplate 68 arm and the rotational axis of the pitch horn 78 connection within the propeller/fan hub 70.

The forward end of the propeller/fan pitch link 72 has flanges that provides the bolted connection with the aft end of the hub/swashplate alignment link 74. The aft end of the propeller/fan pitch link 72 has flanges that provide the bolted connection with the single flange on the pitch horn 78. This bolted connection allows rotation of the propeller/fan pitch link 72 around the longitudinal axis of the bolt but does not allow rotation of the propeller/fan pitch link 72 around any axis perpendicular to the longitudinal axis of the bolt and completes the connection of the propeller/fan pitch link 72.

The propeller/fan hub 70 attaches to the drive shaft 20 from its center bore that is aligned with the longitudinal drive shaft 20 axis. The inside diameter of the center bore has a female spline that mates with a male spline on the outside diameter of the drive shaft 20. The propeller/fan hub 70 rotates around the longitudinal drive shaft 20 axis and is fixed from translation along this axis by a shaft retaining ring. The propeller/fan hub 70 has a plurality of housing bores that are angularly spaced equally apart from each other and each have a longitudinal bore axis that is perpendicular to the longitudinal drive shaft 20 axis within the same angular plane.

The pitch horn 78 provides the attachment location for the root end of the propeller/fan blade 80 and is the hinged moment arm connection to the propeller/fan hub 70 used to rotate the propeller/fan blade 80 when the cyclic or collective pitch is changed. The pitch horn 78 shaft is attached to the propeller/fan hub 70 and is supported by a set of bearings located at the outer and inner housing bore of the propeller/fan hub 70. The pitch horn 78 shaft rotates around the longitudinal housing bore axis and is fixed from translation along this axis by a shaft retaining ring. The angle of rotation of the pitch horn 78 relative to a rotation axis that is perpendicular to the longitudinal drive shaft 20 axis is driven by the translational position of the drive flanges on the sliding assembly outer rotating swashplate 68 along the longitudinal drive shaft 20 axis. The translational position of the propeller/fan hub 70 relative to the longitudinal drive shaft 20 axis is fixed and therefore allows rotation of the pitch horn 78 from the changes in the transitional position of the drive flanges. The pitch horn 78 is directly driven by the connection with the propeller/fan pitch link 72 which is driven by the connection to the hub/swashplate alignment link 74 which is driven by the connection to the sliding assembly outer rotating swashplate 68 drive flanges. The angle of rotation of the pitch horn 78 remains constant when the rotational angular plane of the sliding assembly outer rotating swashplate 68 is perpendicular to the longitudinal drive shaft 20 axis. The angle of rotation of the pitch horn 78 has a sinusoidal change with each revolution when the rotational angular plane of the sliding assembly outer rotating swashplate 68 is not perpendicular to the longitudinal drive shaft 20 axis.

The propeller/fan blade 80 attaches to the pitch horn 78 shaft at the root end of the blade 80. The root end of each blade 80 has a housing bore that is parallel with the longitudinal axis of each blade 80. The inside diameter of the propeller/fan blade 80 housing bore has a female spline that mates to a male spline on the outside diameter of the pitch horn 78 shaft. The propeller/fan blade 80 rotates around the longitudinal propeller/fan hub 70 housing bore axis and is fixed from translation with the pitch horn 78 shaft along this axis by a shaft retaining ring. The propeller/fan blade 80 uses a reversible pitch propeller blade 80 airfoil or a symmetrical fan 80 airfoil. This type of blade 80 airfoil will produce positive thrust, negative thrust or neutral thrust depending on the angle of attack created by the collective or cyclic blade 80 pitch control used.

The direction control unit that is located inside of the cockpit consists of a direction control lever that the pilot uses to actuate the forward/reverse collective thrust actuator 30. When the direction control lever is moved to the middle or neutral position, a mechanical or electrical signal is used to actuate the hydraulic or electric forward/reverse collective thrust actuator 30 causing translation of the forward/reverse collective thrust actuator 30 rod end to the middle position. This position directly translates the collective pitch of the blade 80 to a neutral angle of attack through the system of mechanisms described in this embodiment which causes neutral thrust. Likewise, if the direction control lever is moved forward, a mechanical or electrical signal is used to actuate the hydraulic or electric forward/reverse collective thrust actuator 30 causing translation of the forward/reverse collective thrust actuator 30 rod end to the forward position. This position directly translates the collective pitch of the blade 80 to a positive angle of attack through the system of mechanisms described in this embodiment which causes forward thrust. Likewise also, if the direction control lever is moved toward reverse, a mechanical or electrical signal is used to actuate the hydraulic or electric forward/reverse collective thrust actuator 30 causing translation of the forward/reverse collective thrust actuator 30 rod end to the aft position. This position directly translates the collective pitch of the blade 80 to a negative angle of attack through the system of mechanisms described in this embodiment which causes reverse thrust. Operation of the direction control unit does not require the use of a complex computer program interface since every operation is proportional to the movement of the directional control lever.

The steering control that is located inside of the cockpit consists of a pair of airplane type rudder foot pedals and/or an airplane type steering wheel that the pilot uses to actuate the phase lag elevator effect cyclic actuator 40 and the phase lag rudder/anti-torque effect cyclic actuator 50. When the steering wheel is located in the neutral unturned position, the phase lag elevator effect cyclic actuator 40 and the phase lag rudder/anti-torque effect cyclic actuator 50 rod ends remain in their middle position which fixes the sliding assembly outer rotating swashplate 68 in a perpendicular rotating plane relative to the longitudinal drive shaft 20 axis. This position relates to an even propeller/fan hub 70 thrust that does not cause aircraft pitch or yaw response. When the steering wheel is pushed forward from the neutral position, the phase lag elevator effect cyclic actuator 40 rod end moves from the middle position to a forward position causing a cyclic forward/aft thrust couple from the propeller/fan hub 70. This thrust couple causes a downward nose pitch for an aircraft moving in a forward direction or a downward tail pitch for an aircraft moving in a reverse direction. When the steering wheel is pulled backward from the neutral position, the phase lag elevator effect cyclic actuator 40 rod end moves from the middle position to a aft position causing a cyclic forward/aft thrust couple from the propeller/fan hub 70. This thrust couple causes an upward nose pitch for an aircraft moving in a forward direction or an upward tail pitch for an aircraft moving in a reverse direction.

When rudder foot pedals are not desired to be used or installed in the cockpit for yaw or anti-torque control, steering wheel control can be made to be used in lieu of the rudder foot pedals. When the steering wheel is turned to the right from the neutral position or the right rudder foot pedal is depressed, the phase lag rudder/anti-torque effect cyclic actuator 50 rod end moves from the middle position to a aft position causing a cyclic forward/aft thrust couple from the propeller/fan hub 70. This thrust couple causes a right nose yaw for an aircraft moving in a forward direction or a right tail yaw for an aircraft moving in a reverse direction. When the steering wheel is turned to the left from the neutral position or the left rudder foot pedal is depressed, the phase lag rudder/anti-torque effect cyclic actuator 50 rod end moves from the middle position to a forward position causing a cyclic forward/aft thrust couple from the propeller/fan hub 70. This thrust couple causes a left nose yaw for an aircraft moving in a forward direction or a left tail yaw for an aircraft moving in a reverse direction.

The applications of the propulsive tail propeller/fan assembly 10 maneuvering control system depicted by this embodiment will be evident to those of skill in the art as to the various embodiments that are possible. One possible embodiment would be a retrofit of a conventional single rotor head helicopter by removing the tail section and tail rotor from the rotorcraft fuselage 90 and replacing them with a propulsive tail propeller/fan assembly 10 that includes a propeller/fan tail cone 76 and a propulsive tail duct 96. This retrofit would complement and interface with the existing main rotor and tail rotor controls to provide increased speed, maneuverability, altitude and range for the helicopter.

Another possible embodiment would be a retrofit of a conventional coaxial rotor head helicopter by removing the tail section from the rotorcraft fuselage 90 and replacing them with a propulsive tail propeller/fan assembly 10 that includes a propeller/fan tail cone 76 and a propulsive tail duct 96. This retrofit would complement and interface with the existing main rotor controls to provide increased speed, maneuverability, altitude and range for the helicopter.

Another possible embodiment would be a retrofit of a conventional compound coaxial rotor head helicopter by removing the tail section and tail propeller from the rotorcraft fuselage 90 and replacing them with a propulsive tail propeller/fan assembly 10 that includes a propeller/fan tail cone 76 and a propulsive tail duct 96. This retrofit would complement and interface with the existing main rotor and tail propeller controls to provide increased speed, maneuverability, altitude and range for the helicopter.

Another possible embodiment would be a new designed fixed wing aircraft that replaces the conventional tail which includes the vertical stabilizer, rudder, horizontal stabilizer and elevator with a propulsive tail propeller/fan assembly 10 that includes a propeller/fan tail cone 76 and propulsive tail duct 96. This retrofit would provide increased speed, maneuverability, altitude and range for the aircraft.

Another possible embodiment would be a new designed X-wing rotorcraft that uses a high lift, low drag X-wing main rotor hub assembly 92 and rotor wing blade 94 for vertical lift located on the top of the rotorcraft fuselage 90 that transitions to a slowed or stopped wing in flight. The X-wing blade 94 would utilize a modified circular arc high camber airfoil that is symmetrical about the center point of the chord length toward the leading and trailing edges. This airfoil would transition from the outer blade length to a thicker low chamber symmetrical leading/trailing edge airfoil at the inside root end of the X-wing blade 94. The rotorcraft fuselage 90 would utilize a tail section and tail rotor with a propulsive tail propeller/fan assembly 10 that includes a propeller/fan tail cone 76 and propulsive tail duct 96. This rotorcraft with a an X-wing rotor hub assembly 92 for vertical lift that transitions to a slowed or stopped wing in flight combined with a propulsive tail propeller/fan assembly 10 that provides all flight thrust and that controls all maneuvering and anti-torque during hover and flight would provide very efficient vertical lift and high speed flight characteristics. The rotorcraft will also exhibit other beneficial flight characteristics shared with the other retrofitted embodiments including rapid acceleration from hover and deceleration to hover without having to pitch the aircraft nose up or down, hovering with the aircraft nose up or down and forward or reverse flight. When the main rotor shaft angle is fixed at an aft tilt angle from vertical, all of the wing blades will have a positive angle of attack in forward flight which provides positive lift when the rotor hub is in rotation or stopped. This can be better accomplished by having the shaft angle at vertical and applying cyclic to the propulsive tail propeller for a positive nose up angle in forward flight or a nose down angle in a reverse flight direction. An aileron control surface can be used on a rear landing gear pylon or horizontal stabilizer to provide roll control and provide anti-torque control for the propulsive tail propeller/fan if main rotor cyclic is not used or if the dissymmetry of lift roll is not sufficient to provide balance. This control surface can be used in reverse flight mode to provide the same effect for reverse flight torque.

The turbojet/turbofan powered vectored thrust maneuvering control system depicted by this embodiment can produce all of the forward, neutral and aft thrust required to accelerate, continuously propel and decelerate an aircraft in a forward or reverse flight direction. This system can also provide the aircraft with directional control including pitch, yaw and helicopter single rotor head anti-torque. Forward, neutral and reverse thrust control is powered by the thrust reverser actuators 100. The actuator 100 is connected to a sliding assembly 108 that transitions in a forward and aft direction along the top and bottom edge of the rectangular cutouts in the duct. The reverse thrust cutouts are each located on the port and starboard side of the duct and are opposite and parallel with each other. The actuator 100 rod end is bolted to the sliding assembly 108 that moves in a linear track that is attached to the fuselage between the outer skin, the duct 20 and the frames. The strut arm 106 attaches to the sliding assembly 108 on the interior side wall surface of the duct 20 by a bolted connection used by the rod end connection of the actuator 100. The strut arm 106 is also attached to the center edge of each door diverter vane also known as a (DDV) 104 and used for thrust reversing. This attachment is by a pin connection and provides the final link from the sliding assembly 108 to the DDV 104. Each DDV 104 used for thrust reversing has two strut arms 106 that each attach to the center edge of the DDV 104 and provide the linkage required to open and retract the DDV 104 from sealing the cutout in the duct 20 up to a 45 degree position inside the exhaust stream of the duct 20. The DDV's 104 which are opposite to each other open and close at the same linear rate and at the same time in opposite rotational directions so that the four thrust reverser actuator 100 rod ends that control the DDV's 104 are translating in the same forward or aft direction at the same time and same linear rate of motion. This ensures that the reverse thrust force on the port and starboard sides of the aircraft is equal and uniform so that an unbalanced thrust couple is not created. The rectangular cutouts contain rectangular grates 112 or cascades located in the middle between each upper and lower sliding assembly 108 track. The grates 112 contain fixed rectangular cells that are parallel with each other and direct exhaust flow 45 degrees forward to the longitudinal direction of the duct 20. The grates 112 are normal to the duct 20 face and are located between the outer skin of the aircraft and the outer face of the duct 20. They extend from the forward end of the cutout to the aft end of the cutout. The grates 112 are attached to the structural frames along the perimeter of each rectangular cutout.

As the jet engine thrust is diverted to these grates 112, the thrust is then diverted through the cells of each grate 112 and directed lateral to the duct 20 at a forward 45 degree angle. The thrust exits out at 45 degrees forward to the outer skin surface of the aircraft. The outer surface of each grate 112 is has weak spring loaded hinged slats 114 that are blown open by the diverted thrust. The length of each slat 114 is parallel with longitudinal length of the duct 20. These slats 114 cover the exterior surface of each grate 110 when not being blown open and are flush with the outer skin surface of the aircraft for aerodynamic efficiency.

For lateral maneuvering including yaw and pitch, thrust control is powered by the elevator and rudder effect actuators 100. There are two elevator effect and two rudder effect actuators. The elevator effect actuators 100 are located opposite to each other with the range of translation in the same longitudinal direction as the duct 20. The upper elevator effect actuator 100 is located on the upper outer face of the duct 20 at the middle of the face. The lower elevator effect actuator 100 is located on the lower outer face of the duct 20 at the middle of the face. Both actuators 100 are located between the outer skin and the duct 20 and between the station frames of the aircraft. The rudder effect actuators 100 are located opposite to each other with the range of translation in the same longitudinal direction of the duct 20. The port side rudder effect actuator 100 is located port side outer face of the duct 20 at the middle of the face. The starboard side rudder effect actuator 100 is located on the starboard side outer face of the duct 20 at the middle of the face. Both actuators 100 are located between the outer skin and the duct 20 and between the station frames of the aircraft. Each translating rod end on the actuator 100 is oriented to the aft of the aircraft and is connected to a sliding assembly 108 that translates in the same longitudinal direction as as the actuator 100. The sliding assembly 108 translates in a set of tracks that are attached to the frame that is located at the forward side of the triangular cutouts in the duct 20 used for lateral thrust vectoring. The other end of the track is attached to the frame that is located at the aft side of the triangular cutouts base where the track transverses the center and bisects the triangular cut out's base to the longitudinal duct 20 direction.

The base of each triangular cutout extends the full width of the duct 20 face with the apex of the cutout at the forward center of the duct 20 face relative to the base. The duct 20 has four triangular cutouts that are adjacent to each other on each of the top, bottom, port and starboard faces of the duct 20. Each cutout is sealed by a triangular door diverter vane to be known as a DDV 102, that is hinged at the aft base of each cutout. Each DDV 102 can open inward into the center of the duct up to 45 degrees with the apex rotating to the center line of the rectangular duct 20 cross section. Each DDV 102 can independently rotate open to 45 degrees without interfering with the motion of the other DDV's 102. Each DDV 102 is controlled by a single strut arm 106 with a lug end that attaches to a hinge in located at the center of each DDV 102. The strut arm 106 is used to rotate the DDV 102 open or closed. The other end of the strut arm is attached to the sliding assembly 108 at a common fitting that has a hinge pin that is used to connect the rod end of each of the elevator or rudder effect actuators 100 with the lug end of the strut arm 106. As the sliding assembly 108 translates in a linear motion aft along the track in the center of the triangular cutout, the strut arm 106 unfolds to allow the DDV 102 to open into the duct 20. As the DDV 102 opens into the duct 20, the aftward traveling jet engine thrust is progressively diverted by the DDV 102 into the triangular cutout in the duct 20. The triangular cutouts contain two triangular grates 110 or cascades located on each side of the sliding assembly 108 track. The triangular grates 110 contain fixed rectangular cells that are parallel with each other and are normal to the longitudinal direction of the duct 20. The grates 110 are normal to the duct 20 face and are located between the outer skin of the aircraft and the outer face of the duct 20. They extend from the forward apex of the cutout to the aft base of the cutout. The two grates 110 are equal and opposite pieces located on each side of the sliding assembly track. The grates 110 are attached to the structural frames along the perimeter of each triangular cutout.

As the jet engine thrust is diverted to these grates 110, the thrust is then diverted through the cells of each grate 110 and directed lateral to the duct 20. The thrust exits out normal to the outer skin surface of the aircraft. The outer surface of each grate 110 is has weak spring loaded hinged slats 114 that are blown open by the diverted thrust. The length of each slat 114 is parallel with longitudinal length of the duct 20. These slats 114 cover the exterior surface of each grate 110 when not being blown open and are flush with the outer skin surface of the aircraft for aerodynamic efficiency. Each DDV 102 is independent of the other DDV's 102 and depends on the input received by either the cockpit rudder pedal controls or the steering wheel controls. When an opposite DDV 102 opens or closes, the matching DDV 102 will not translate until the opposite DDV 102 has completed it's cycle from the cockpit control signal. This makes for a progressive elevator and rudder control that does not require computer control. When the pilot depresses the right rudder pedal, the starboard rudder effect actuator 100 opens the starboard DDV 102 which causes diverted thrust from the tail to yaw the nose of the aircraft to the right. When the pilot releases the right rudder pedal, the starboard rudder effect actuator 100 closes the starboard DDV 102 which causes the aircraft to continue straight at it's current path. The equal and opposite effect occurs with the left rudder pedal control. When the pilot pulls the steering wheel back from the neutral position, the upper elevator effect actuator 100 opens the the upper DDV 102 which causes diverted thrust to push the tail down and pitch the nose of the aircraft up. When the pilot pushes the steering wheel forward to the neutral position, the upper elevator effect actuator 100 closes the upper DDV 102 which causes the aircraft to continue straight at its current path. The equal and opposite effect occurs when the steering wheel is pushed forward from the neutral position. Since the rudder pedal control can only be done in sequence and steering wheel control be done in sequence, this makes the all of DDV's 102 dependent of the cockpit control and independent of the other DDV's 102. This is also the case with the directional control lever that controls the aft module thrust reversing DDV's 104. When the pilot pushes the lever forward from the neutral position, both DDV's 104 close which causes all thrust to be directed aft. This causes reverse speed to be reduced or forward speed to increase. When the lever is pulled back to the neutral position, both DDV's 104 open partially an equal amount which causes the aft thrust to be reduced and the reversed thrust to be initiated so that there is a net neutral thrust. When the lever is pulled backward from the neutral position, both DDV's 104 open equally to a maximum 45 degrees which blocks all aft thrust and causes full reverse thrust. This causes forward speed to be reduced or reverse speed to be increased. The forward, neutral and reverse thrust control is independent of the lateral control operations and therefore makes this thrust vectoring control system possible for aircraft hovering and high speed control.

1. An aircraft propulsion and control system that consists of:
an aircraft tail assembly that rigidly mounts a rotating drive shaft within a plurality of drive shaft bearings and from which is powered by one or more externally sourced turboshaft engines; through which a propeller/fan hub containing a plurality of pitch horns attaching same said number of propeller/fan blades is driven; and from which a same said plurality of propeller/fan pitch links are connected and attached to a same said number of hub/swashplate alignment links; which all rotate about the common longitudinal drive shaft axis and receive translational control from the outer rotating swashplate to which they are attached; and thereby transmit such control to said pitch horns transverse axis of rotation by which causes changes to the pitch of said attached plurality of propeller/fan blades relative to the plane of perpendicularity with said drive shaft axis and thereby changing the force and direction of thrust from each individual propeller/fan blade relative to the translational and directional control that each receives.

2. The aircraft propulsion and control system of claim 1, further consisting of a inner non rotating swashplate attached to said outer rotating swashplate by a swashplate bearing and together connected to and pivotal about a fixed spherical bearing that is attached to a sliding assembly that bounds and transitions the said longitudinal drive shaft axis.

3. The aircraft propulsion and control system of claim 2, further consisting of said sliding assembly from which a phase lag elevator effect cyclic actuator and a phase lag rudder/anti-toque effect actuator is attached and to which both are attached to said inner non rotating swashplate and thereby transferring direct control to said outer rotating swashplate.

4. The aircraft propulsion and control system of claim 3, further consisting of said sliding assembly to which an engagement link is connected and attached to an alignment link from which said engagement link pivots such that a transition of the forward/reverse thrust actuator rod end that is connected to said engagement link will cause the said sliding assembly to transition said longitudinal drive shaft axis with equal and opposite force and thereby causing equal translational movement and rotation to all said pitch links at their current position of rotation relative to said propeller/fan hub and thereby equally changing the pitch of all said propeller/fan blades from their current pitch.

5. The aircraft propulsion and control system of claim 4, further consisting of a direction control lever that is located in the cockpit which when progressively moved to a forward or a reverse position from its center neutral position causes an equally opposite linear translation of said forward/reverse thrust actuator rod end for each lever movement direction thereby causing a linear increase in forward or reverse thrust respectively.

6. The aircraft propulsion and control system of claim 5, further consisting of a steering control system that includes a pair of rudder foot pedals and/or a steering wheel that are located in the cockpit. The right or left rudder foot pedal when progressively depressed will result in an equally opposite linear translation of the said phase lag rudder/anti-torque effect cyclic actuator rod end for each pedal movement thereby causing a linear increase in right yaw thrust or left yaw thrust respectively. When the steering wheel is progressively turned to the right or the left from the center neutral position, the phase lag rudder/anti-torque effect cyclic actuator rod end will have an equally opposite linear translation for each steering wheel rotational direction thereby causing a linear increase in right yaw thrust or left yaw thrust respectively. When the steering wheel is progressively pushed forward or pulled backward from the center neutral position, the phase lag elevator effect cyclic actuator rod end will have an equally opposite linear translation for each steering wheel movement direction thereby causing a linear increase in nose down pitch thrust or nose up pitch thrust respectively.

7. A method as recited in claim 6, when applied as a retrofit to an existing single rotor head helicopter by replacing the tail section and tail rotor would increase speed, maneuverability, altitude and range of the helicopter.

8. A method as recited in claim 6, when applied as a retrofit to an existing coaxial rotor head helicopter by replacing the tail section would increase speed, maneuverability, altitude and range of the helicopter.

9. A method as recited in claim 6, when applied as a retrofit to an existing compound coaxial rotor head helicopter by replacing the tail section and tail propeller would increase speed, maneuverability, altitude and range of the helicopter.

10. A method as recited in claim 6, when applied to a new design fixed wing aircraft would increase speed, maneuverability, altitude and range of the aircraft over a conventional design.

11. A method as recited in claim 6, when applied to a new design X-wing rotorcraft would enable the design and build of a new aircraft that would have very efficient vertical lift and high speed flight characteristics.

12. A method as recited in claim 4, when applied to a new design fixed wing UAV aircraft would increase speed, maneuverability, altitude and range of the aircraft over a conventional design.

13. A method as recited in claim 4, when applied to a new design single rotor head helicopter UAV aircraft would increase speed, maneuverability, altitude and range of the aircraft over a conventional design.

14. A method as recited in claim 4, when applied to a new design coaxial rotor head helicopter UAV aircraft would increase speed, maneuverability, altitude and range of the aircraft over a conventional design.

15. A method as recited in claim 4, when applied to a new design compound coaxial rotor head helicopter UAV aircraft would increase speed, maneuverability, altitude and range of the aircraft over a conventional design.

16. A method as recited in claim 4, when applied to a new design X-wing UAV rotorcraft would enable the design and build of a new aircraft that would have very efficient vertical lift and high speed flight characteristics.

17. An aircraft propulsion and control system that consists of an aircraft containing a duct with thrust powered by a turbojet/turbofan engine that contains modules with actuator powered door diverter vanes (DDV's) used to provide full forward, neutral or reverse thrust control and full lateral control including pitch and yaw during hovering and forward and reverse flight modes and can provide partial or total vertical lift.
